(19) United States
(12) Patent Application Publication
(10) Pub. No.: US 2026/0138831 A1
(43) Pub. Date: May 21, 2026

(54) WALL MOVING SYSTEM

(71) Applicant: American Honda Motor Co., Inc., Torrance, CA (US)

(72) Inventors: Harold Michael KOENIG, Riverside, CA (US); Alfred Johannes PORSCHE, Leduc County AB (CA)

(21) Appl. No.: 18/953,895

(22) Filed: Nov. 20, 2024

(51) Int. Cl. B65G 17/20; B65G 13/11

(52) U.S. Cl. CPC B65G 17/20; B65G 13/11; B65G 2201/022

(57) ABSTRACT

Wall moving systems include a conveying system for moving a wall a short distance. The conveying system can move a wall from an assembly area, where the wall is constructed, to a loading area where the wall is loaded onto a swap body that can be placed on a vehicle for transportation to a construction site. A wall can be built on a bottom conveyor line and pivoted into a vertical position on the same. The conveying system has a top conveyor including a track that can continuously secure the wall in the vertical position while also guiding movement in a horizontal direction on the bottom conveyor. Wall moving systems can include a configuration of tracks and spacers mounted in a swap body for seamlessly loading a wall from the conveying system and storing the walls in the swap body in an organized and break-resistant arrangement.

### BACKGROUND

Prefabricating walls for building structures can expedite construction. Prefabricated walls can be built on an assembly line in a remote location and then transported to the construction site for installation in building structures (e.g., commercial buildings or homes). The heavy weight and large dimensions of prefabricated walls can require multiple people to coordinate lifting and carrying the walls from the assembly line to a storage area or to a transportation container or vehicle and loading thereon. This requirement slows the process of moving and/or loading prefabricated walls.

There is a need in the art for a system and method that addresses the shortcomings discussed above.

### SUMMARY

In one aspect, the disclosure provides a wall moving system that can comprise a bottom conveyor including a base and a plurality of rollers rotatably connected to the base. The wall moving system can further comprise a top conveyor including a track with a channel and a slot, the top conveyor disposed above the bottom conveyor such that the top conveyor is parallel to the top conveyor. The wall moving system can further comprise a first spherical pin having a first substantially spherically shaped head, a first neck, and a first threaded rod. The wall moving system can further comprise a second spherical pin having a second substantially spherically shaped head, a second neck, and a second threaded rod.

The wall moving system can include a cylindrically shaped pin having a threaded rod.

The channel can be u-shaped and the slot can extend along a longitudinal axis of the channel.

The first neck and the second neck can be cylindrical in shape.

The first neck and the second neck can both have a diameter that fits within the slot.

The bottom conveyor can be a gravity roller conveyor.

The bottom conveyor can be a line-shaft conveyor.

In one aspect, the disclosure provides a wall moving system can comprise a bottom conveyor including a base and a plurality of rollers rotatably connected to the base. The wall moving system can further comprise a top conveyor including a track with a channel and a slot, the top conveyor disposed above the bottom conveyor such that the top conveyor is parallel to the top conveyor. The wall moving system can further comprise a first support suspending the top conveyor above the bottom conveyor. The wall moving system can further comprise a first pin having a first head, a first neck that is smaller than the head, and a first threaded rod. The wall moving system can further comprise a second pin having a second head, a second neck that is smaller than the head, and a second threaded rod.

The wall moving system can include a cylindrically shaped pin having a threaded rod.

The channel can be u-shaped and the slot extends along a longitudinal axis of the channel.

The first neck and the second neck can be cylindrical in shape.

The first neck and the second neck can both have a diameter that fits within the slot.

The bottom conveyor can be a gravity roller conveyor.

The bottom conveyor can be a line-shaft conveyor.

In one aspect, the disclosure provides a wall moving system that can comprise a bottom conveyor including a base and a plurality of rollers rotatably connected to the base. The wall moving system can comprise a top conveyor including a first track with a first channel and a first slot, the top conveyor disposed above the bottom conveyor such that the top conveyor is parallel to the top conveyor. The wall moving system can comprise a first pin having a first head, a first neck that is smaller than the head, and a first threaded rod. The wall moving system can comprise a second pin having a second head, a second neck that is smaller than the head, and a second threaded rod. The wall moving system can comprise a second track with a second channel and second slot, the second track mountable in a swap body.

The base can include legs adjustable to change a height of the base.

The base can include wheels.

The wall moving system can further comprise legs, wherein the wheels are attached to the legs.

The bottom conveyor can be a gravity roller conveyor.

The bottom conveyor can be a line-shaft conveyor.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

While various embodiments are described, the description is intended to be exemplary, rather than limiting, and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature or element of any embodiment may be used in combination with or substituted for any other feature or element in any other embodiment unless specifically restricted.

This disclosure includes and contemplates combinations with features and elements known to the average artisan in the art. The embodiments, features, and elements that have been disclosed may also be combined with any conventional features or elements to form a distinct invention as defined by the claims. Any feature or element of any embodiment may also be combined with features or elements from other inventions to form another distinct invention as defined by the claims. Therefore, it will be understood that any of the features shown and/or discussed in the present disclosure may be implemented singularly or in any suitable combination. Accordingly, the embodiments are not to be restricted except in light of the attached claims and their equivalents. Also, various modifications and changes may be made within the scope of the attached claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 shows a perspective view of a wall including multiple pins according to an embodiment.

FIG. 2 shows a perspective view of a wall conveying system and a swap body, according to an embodiment.

FIG. 3 shows a perspective view of swap body with a plurality of walls loaded between top spacers and bottom spacers, according to an embodiment.

FIG. 4 shows a rear view of swap body, according to an embodiment.

FIG. 5 shows a side view of a wall conveying system, according to an embodiment.

FIG. 6 shows rear view of a swap body having roof doors opened, according to an embodiment.

FIG. 7 shows a top view of a floor of a swap body having a pattern of holes, according to an embodiment.

FIG. 8 shows multiple walls positioned in a wall module pattern on the swap body floor of FIG. 7, according to an embodiment.

FIG. 9 shows a perspective view of a wall module, according to an embodiment.

### DESCRIPTION OF EMBODIMENTS

Generally disclosed are embodiments of wall moving systems including wall conveying systems and wall transportation systems. The wall transportation systems and wall conveying systems can be used to convey walls along short distances (e.g., within a wall assembly area) and to transport walls from assembly area to building sites where the walls are to be installed in building structures. In some embodiments, a wall transportation system may include a wall conveying system and a configuration of tracks and spacers for a swap body. In some embodiments, the spacers extend the entire length of the tracks. In other embodiments, multiple shorter spacers are aligned with one another in a path that extends between two tracks to provide cushioning/protection between two walls loaded on the two tracks.

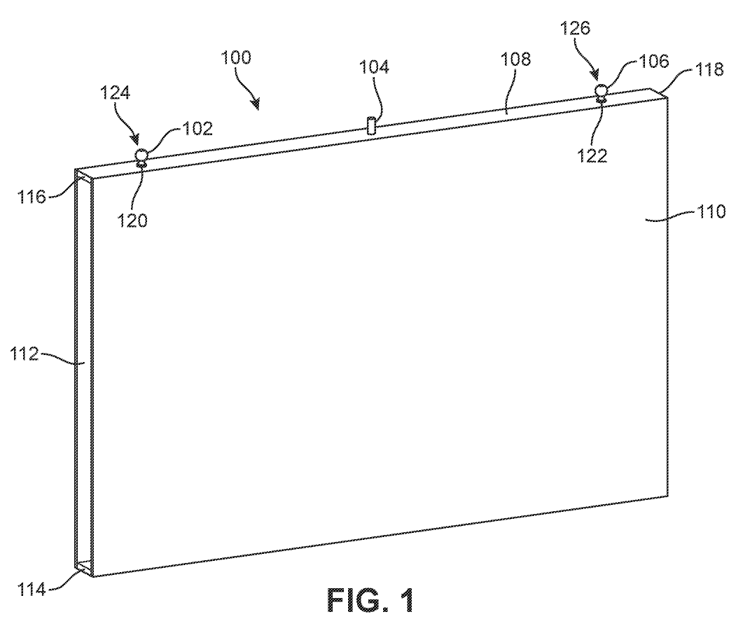

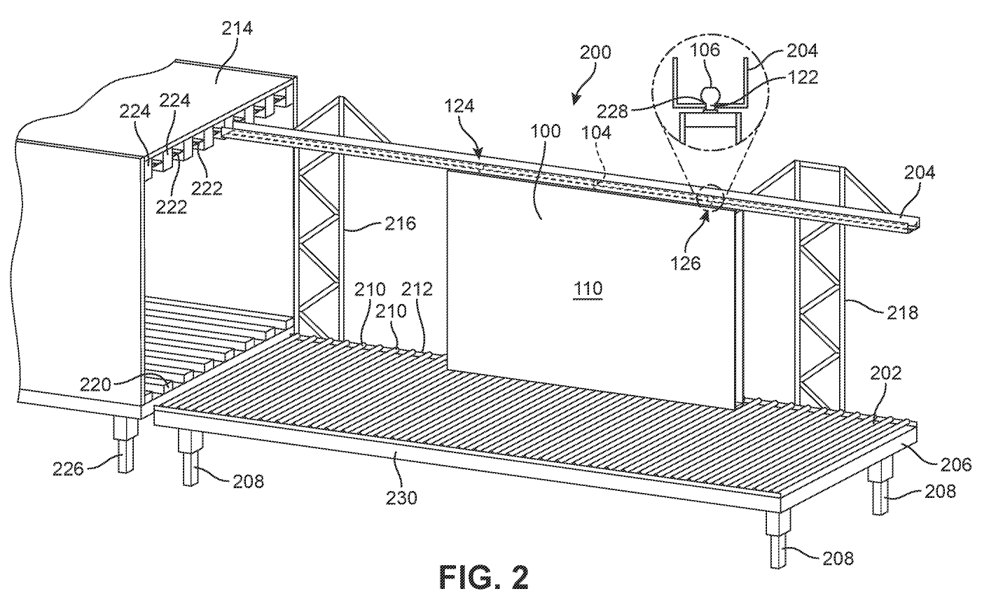

The disclosed wall conveying system can include pins attached to a wall. FIG. 1 shows a perspective view of a wall 100 including multiple pins according to an embodiment. The multiple pins include a first spherical pin 124, a second spherical pin 126, and a cylindrical pin 104 attached to a first lumber board 108. FIG. 2 shows a perspective view of a wall conveying system 200 and a swap body 214, according to an embodiment. The wall conveying system can include a bottom conveyor and a top conveyor. For example, wall conveying system 200 includes a bottom conveyor 202 and a top conveyor 204. By having a bottom conveyor and a top conveyor, the wall can be secured in a vertical position and easily moved in a horizontal direction without the need for people to lift or hold the wall. For example, if any horizontal direction comprises an x-y plane, then the wall can move in a straight line and/or in curved paths. Further, the conveyor may move in a vertical (i.e. z) direction as well.

In some embodiments, a wall can be assembled in a horizontal position on the wall conveying system and then a first end (e.g., first lumber board 108) of the wall can be pivoted up around a second end (e.g., second lumber board 114) of the wall to move the wall into a vertical position. For purposes of clarity, when the wall is discussed as being in the vertical position, the first end is referred to as the “top end” and the second end is referred to as the “bottom end.” Wall 100 can slide along wall conveying system 200 in a vertical position from one end of wall conveying system 200 to another end where swap body 214 is positioned in alignment with wall conveying system 200. Then, the same sliding motion can be used to seamlessly load wall 100 into swap body 214 without the help of people lifting wall 100 or manually holding wall 100 in a vertical position. FIGS. 2-4 show a configuration of tracks and spacers (i.e., top spacers 224, bottom spacers 220, and tracks having channels 222) for a swap body 214, according to an embodiment. Wall 100 can slide along bottom conveyor 202 into a track mounted in swap body 214 that is aligned with top conveyor 204.

As previously mentioned, the wall conveying system can include a bottom conveyor and a top conveyor. By having a bottom conveyor and a top conveyor, the wall can be secured in a vertical position and easily moved in a horizontal direction without the need for people to lift or hold the wall. The top of the wall can be mounted in the top conveyor with the bottom conveyor supporting a bottom end of the wall. In this way, workers can be free to walk away from the wall after it is assembled (e.g., to complete other tasks) and come back to the wall to move the wall along the conveying system at a later time. Rather than coordinating multiple workers to hold or move the wall, an individual person can push the wall along the disclosed wall conveying system without help from others. In some embodiments, the bottom conveyor can be motorized and a person can simply use a switch to move the wall along the conveying system.

In the embodiment shown in FIG. 2, bottom conveyor 202 is a gravity roller conveyor. Bottom conveyor 202 includes a base 206, legs 208, and a plurality of rollers 210 rotatably connected to base 206. Base may include elongate pins (not shown) extending from a first side 212 of base 206 to a second side 230 of base 206. Rollers 210 can be mounted on the elongate pins in a manner allowing rollers 210 to freely rotate. Bottom conveyor 202 includes four legs 208 supporting base 206. However, in other embodiments, a different number of legs may be included. The number of legs can be selected based on a variety of factors. For example, the number of legs can be selected based the size, shape, and/or weight of the base. The legs provide support to the base. In some embodiments, the legs can be adjustable in height. For example, legs 208 are adjustable. By making the legs adjustable, the height of bottom conveyor 202 may be adjustable. In this way, bottom conveyor 202 can be adjusted to accommodate different sized walls or to accommodate different swap body heights.

While the embodiment shown in FIG. 2 includes a gravity roller conveyor, it is understood that other types of bottom conveyors may be used (e.g. conveyor belts, or conveyors of any other type). For example, the bottom conveyor may be motorized. In some embodiments, the bottom conveyor may include a line-shaft conveyor that includes rollers driven by a motorized belt. In such embodiments, the line-shaft conveyor can automatically move the wall without a person pushing the wall along the wall conveying system. The type of bottom conveyor may be selected based on a variety of factors. For example, the type of bottom conveyor may be selected based on the environment the walls are being assembled and conveyed in and/or the weight of the walls being moved.

In some embodiments, the legs of the bottom conveyor 202 may include wheels to move the track into a new location or to adjust the position of the track with respect to an assembly area and/or a container (e.g., swap body) or vehicle. In some embodiments, the wheels may include locks to prevent the wheels from rolling when desired. In some embodiments, the wheels may be connected to the legs in a way that allows for rolling along only one axis. For example, the wheels could be connected to only allow for rolling the bottom conveyor back and forth in a direction perpendicular to the bottom conveyor’s longitudinal axis. In another example, the wheels could be connected to only allow for rolling the bottom conveyor back and forth in a direction parallel to the bottom conveyor’s longitudinal axis. In other embodiments, the wheels may be connected to the legs with a swiveling bracket and fork connector that allows for rolling the wheels in many directions (e.g., casters).

The length of bottom conveyor can be selected based on a variety of factors. For example, the length of the bottom conveyor may be selected based on the size of the walls or the number of walls that are to be mounted on the conveying system at a time. Similarly, the width of bottom conveyor can be selected based on a variety of factors. For example, the width of the bottom conveyor may be selected based on the size of the walls. In some embodiments, the bottom conveyor may be longer than the top conveyor to clear space above the bottom conveyor to make it easier to assemble the wall on the conveyor at one end that does not underlie the top conveyor. Once assembled in a horizontal position on the bottom conveyor, the assembled wall can be rotated with a bottom end supported on the bottom conveyor to move the wall into a vertical position. Then, the wall can be shifted horizontally along the rollers toward the top conveyor to load the pins of the wall into the track of the top conveyor.

The wall conveying system includes a first support 216 and a second support 218 connecting bottom conveyor 202 to top conveyor 204. While two supports are shown, it is understood that a different number of supports may be included. For example, in some embodiments, three or four supports may be included. The number of supports can be selected based on a variety of factors. For example, the number of supports can be selected based the size, shape, and/or weight of the base and/or the top conveyor.

The supports suspend top conveyor 204 above bottom conveyor 202 in a position parallel to bottom conveyor 202, such that track of top conveyor 204 is directly above bottom conveyor 202. In some embodiments, the height of the supports may be adjustable to change the distance between the top conveyor and the bottom conveyor to accommodate walls with different dimensions or to temporarily provide more workspace below the top conveyor.

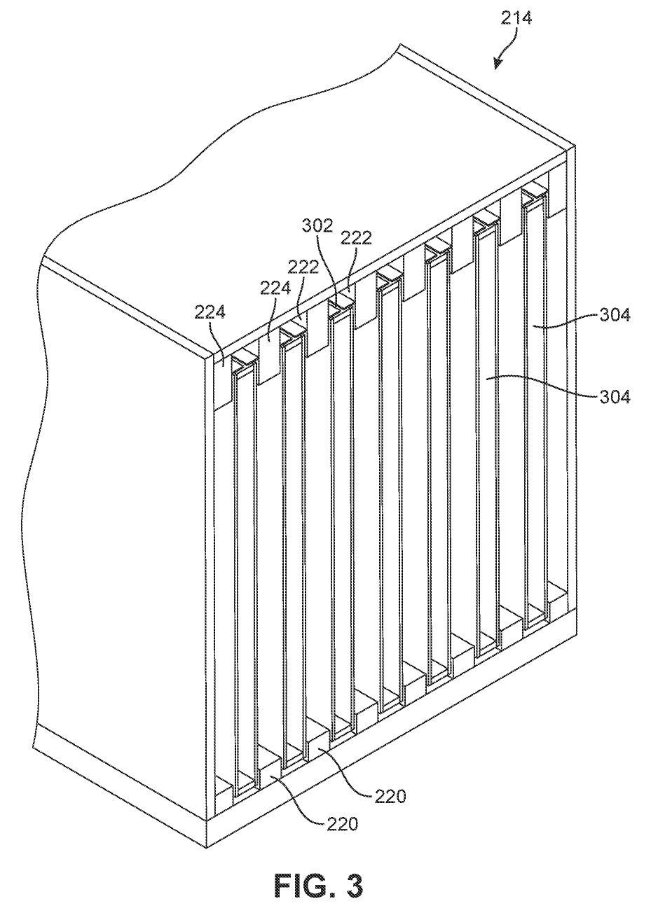

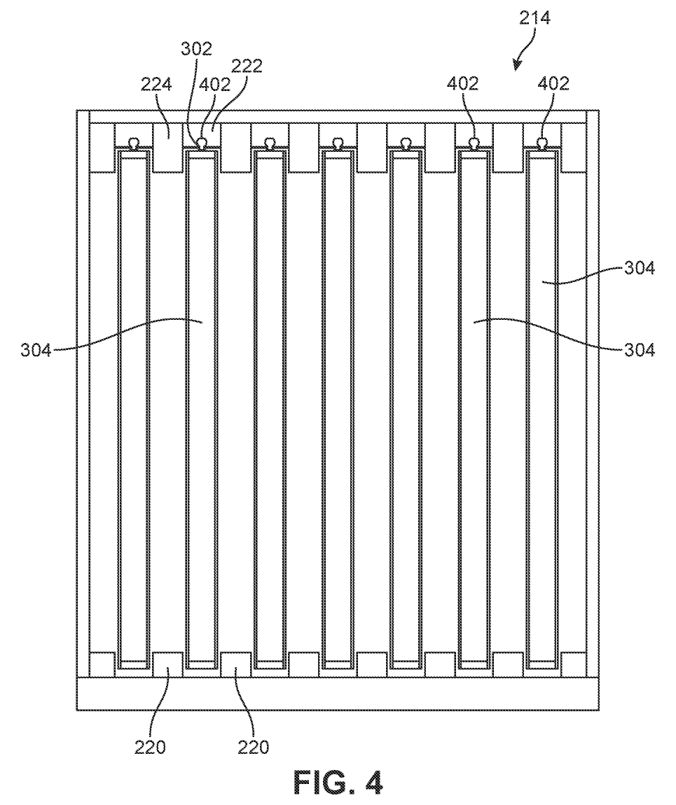

In FIGS. 2-4, the back of swap body 214 is opened to expose the configuration of tracks and spacers mounted within swap body 214. Swap bodies are interchangeable containers or units that can be loaded on a truck, trailer, or railroad car for the transportation of objects, such as materials or goods. Swap body 214 includes a plurality of: top spacers 224, bottom spacers 220, and tracks having channels 222. The tracks can be positioned parallel to one another with top spacers and bottom spacers therebetween to add further support to walls during transit. FIG. 3 shows a perspective view of swap body 214 with a plurality of walls loaded between top spacers 224 and bottom spacers 220. FIG. 4 shows a rear view of swap body 214. In this view, pins 402 of the walls 304 are positioned within track channels with necks of pins 402 positioned within slots 302 of channels 222. In some embodiments, the top spacers and/or bottom spacers can be made of soft foam or other materials that help prevent damage to the walls during transport. In other embodiments, the top spacers and/or bottom spacers can be inflatable bladders to provide additional cushioning between walls during transport.

The swap body can include legs. For example, swap body 214 includes a leg 226 visible in FIG. 2. It is understood that the swap body can have multiple legs (e.g., 4, 5, or 6 legs). The number of legs can be selected based on a variety of factors. For example, the number of legs can be selected based the size, shape, and/or weight of the swap body and/or the types of objects the swap body is to receive. The legs provide support to the swap body. In some embodiments, the legs can be adjustable in height. For example, leg 226 is adjustable. By making the legs adjustable, the height of swap body 214 may be adjustable. In this way, swap body 214 can be adjusted to accommodate different bottom conveyor heights.

In some embodiments, the legs of the swap body may include wheels to move the swap body into a new location or to adjust the position of the swap body with respect to the conveyor system. For example, the swap body can be rolled to align with the bottom conveyor and for the back of the swap body to be close enough to the bottom conveyor for the swap body to receive a wall from the conveyor without lifting the wall. In other words, the wheels can be used to move the swap body into the position shown in FIG. 2. In some embodiments, the wheels may include locks to prevent the wheels from rolling. In some embodiments, the wheels may be connected to the legs in a way that allows for rolling back and forth along only one axis. For example, the wheels could be connected to only allow for rolling the bottom conveyor back and forth in a direction perpendicular to the bottom conveyor’s longitudinal axis. In this example, a wall could slide from the conveying system into a track on the swap body and then the swap body can be moved to align another track of swap body with the track of the conveying system. In another example, the wheels could be connected to only allow for rolling the bottom conveyor back and forth in a direction parallel to the bottom conveyor’s longitudinal axis. In other embodiments, the wheels may be connected to the legs with a swiveling bracket and fork connector that allows for rolling in many directions (e.g., casters).

### WALL

FIG. 1 shows a perspective view of a wall 100 including pins according to an embodiment. The wall may include a frame (only partially shown) made of lumber boards, such as 2-inch x 4-inch and/or 4-inch x 4-inch boards. For example, in FIG. 1, a first lumber board 108 and a second lumber board 114 are visible. The wall may include drywall sheets attached to the frame. For example, in the embodiment of FIG. 2, wall 100 includes a first drywall sheet 110 and a second drywall sheet 112. First drywall sheet 110 can be attached to a first vertical surface of wall 100 and second drywall sheet 112 can be attached to a second vertical surface of wall 100 opposite the first vertical surface.

### PINS

The wall conveying system may include multiple pins. For example, as shown in FIG. 1, a first spherical pin 124, a second spherical pin 126, and a cylindrical pin 104 are attached to first lumber board 108. As discussed in more detail below, the spherical pins can fit within a track to suspend the wall in a vertical position as the bottom end of the wall rests on conveyor rollers. This way, the wall can be held motionless on the conveyor in a vertical position. Or the wall can be held in the vertical position when it slides along the conveyor rollers and the pins move along the top conveyor 204 to move the wall in a horizontal direction. The spherical pins can be located adjacent to lateral ends of the vertical wall such that the wall is secured in a vertical position at both ends. The cylindrical pin can be located near the center of the wall such that, as the wall is unloaded off the conveyor and loaded onto a trailer or elsewhere, the wall is still secured in a vertical position and the loose end of the wall is prevented from swinging around. In other words, the cylindrical pin can help prevent the top end of the wall from moving out of the horizontal path of the track and falling to one side. As wall 100 moves to the left in FIG. 2, first spherical pin 124 will eventually move out of the track and cylindrical pin 104 can keep wall 100 parallel with the track until first spherical pin 124 is secured in a track provided in the trailer. In some embodiments, the conveying system may include more than one cylindrical pin to be inserted between the first and second spherical pins.

### SPHERICAL PIN

The spherical pins may include substantially spherically shaped heads disposed upon necks. For example, first spherical pin 124 may include a first substantially spherically shaped head 102 disposed upon a first neck 120. Second spherical pin 126 may include a second substantially spherically shaped head 106 disposed upon a second neck 122. While first substantially spherically shaped head 102 and second substantially spherically shaped head 106 have a flattened top portion, it is understood that the substantially spherically shaped heads can be fully spherical on the top or can have other shapes on top. The pin heads may be sufficiently large to stay in place above a slot that the pin neck can fit through. In some embodiments, the spherical pins may include a head having a shape other than spherical (e.g., substantially rectangular or conical). The shape of the head may be selected based on a variety of factors. For example, the shape of the pin head may be selected based upon compatibility with the shape of the track channel. It is desirable for the neck of the pin to fit within the slot of the track and the shape of the pin head to stay above the slot within a channel such that the pin head is slidable in the channel track. The shape of the pin head may be selected based on upon the shape of the track channel of the top conveyor.

### NECK

The necks may have a cylindrical shape. For example, first neck 120 and second neck 122 are shown as having a cylindrical shape. In other embodiments, the necks may have other shapes. For example, the cross-sectional shapes of the necks may be rectangular, oval, etc. The shape of the pin neck may be selected based on a variety of factors. For example, the shape of the pin neck may be selected based upon compatibility with the shape of the track slot. It is desirable for the neck of the pin to be smaller than the pin head and to fit within the slot of the track and slide along the slot from one end to the next end.

### THREADED ROD

The spherical and cylindrical pins may include threaded rods that attach the pins to the lumber board, and/or, in some cases, to a drywall sheet of the wall. By using threaded rods, the pins can be attached for conveying the wall before/during installation into a building structure and then removed after installation into the building structure. The threaded rod of the spherical pins may be an extension of the necks.

### LOCATION OF PINS

First spherical pin 124 is attached in a position near a first end 116 of wall 100 and second spherical pin 126 is attached in a position near a second end 118 of wall 100. The spherical shape of the spherical pins enables the spherical pins to be inserted into a u-shaped channel of the track such that the wall can be held in a vertical position by the spherical pins fitting in the u-shaped channel and the necks fitting in a slot formed within the channel.

### CYLINDRICAL PIN

The cylindrical pin can have a substantially cylindrical shape. In other embodiments, the cylindrical pin may have other shapes. For example, the cross-sectional shapes of the cylindrical pins may be rectangular, oval, etc. The shape of the pin may be selected based on a variety of factors. For example, the shape of the pin may be selected based upon compatibility with the size and shape of the track slot.

### TRACK

The top conveyor can include a track having a channel creating a path for pins attached to walls to slide along. For example, top conveyor 204 includes a track with a channel, which has a substantially u-shaped cross-section (see detail in zoomed in view in FIG. 2). The top conveyor can include a slot running along the length of the channel in a direction parallel to a longitudinal axis of the track. For example, top conveyor 204 includes a slot 228 extending along a longitudinal axis of top conveyor 204. The slot can provide a path for a neck of the pin while the head of the pin sits in the channel. In this way, the top conveyor can secure a top end of a wall by pins attached to the top end of the wall to hold the wall in a vertical position. In some embodiments, the track can have a top wall covering the channel.

The track can have dimensions including a length extending along its longitudinal axis, a width perpendicular to its length, and a height perpendicular to both the length and the width. These dimensions may be selected based on a variety of factors. For example, these dimensions may be selected based on the size and shape of the pins. While the track is shown as substantially u-shaped, the track can have a different cross-sectional shape. For example, the square edges of the channel can be more rounded. The height and width of the slot can be selected based on a variety of factors. For example, the height and width of the slot can be selected based on the dimensions of the pins. In some embodiments, the width of the slot can be selected to correspond to the diameter of the cylindrical pin and/or pin necks.

### REMOVABLE TRACK

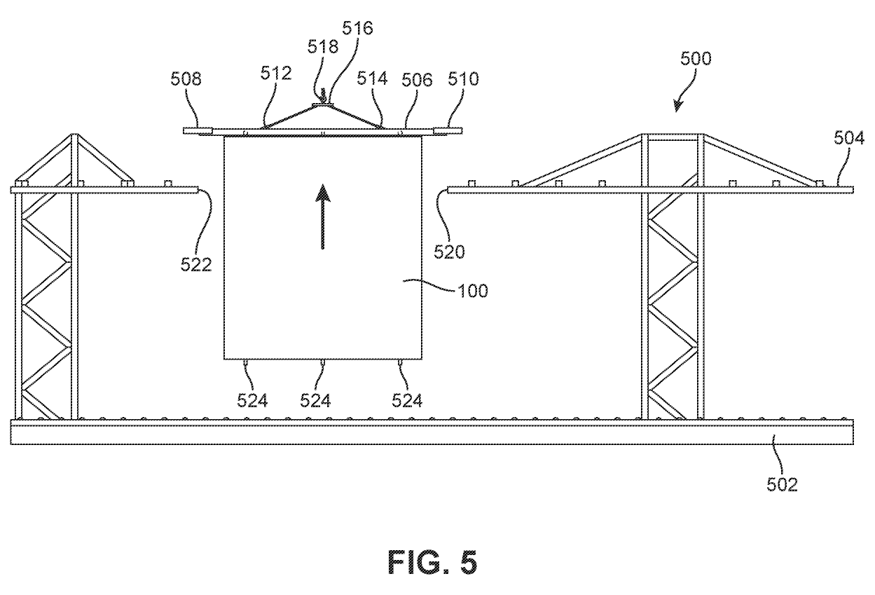

The wall conveying system can include a top conveyor having a track with a removable portion. For example, FIG. 5 shows a side view of a wall conveying system 500, according to an embodiment. Wall conveying system 500 includes a top conveyor 504 and a bottom conveyor 502. FIG. 5 is meant to demonstrate how the track of top conveyor 504 can have a removable portion. Accordingly, a bottom conveyor 502 is not described in detail here. Bottom conveyor 502 can have the same features as those described for bottom conveyor 202. One difference between the two exemplary embodiments is that bottom conveyor 202 is shown with legs and bottom conveyor 502 is shown without legs. It is understood that bottom conveyor 502 could be modified to have legs and/or wheels having the features discussed above with respect to bottom conveyor 202. It is also understood that bottom conveyor 202 could be modified to have no legs.

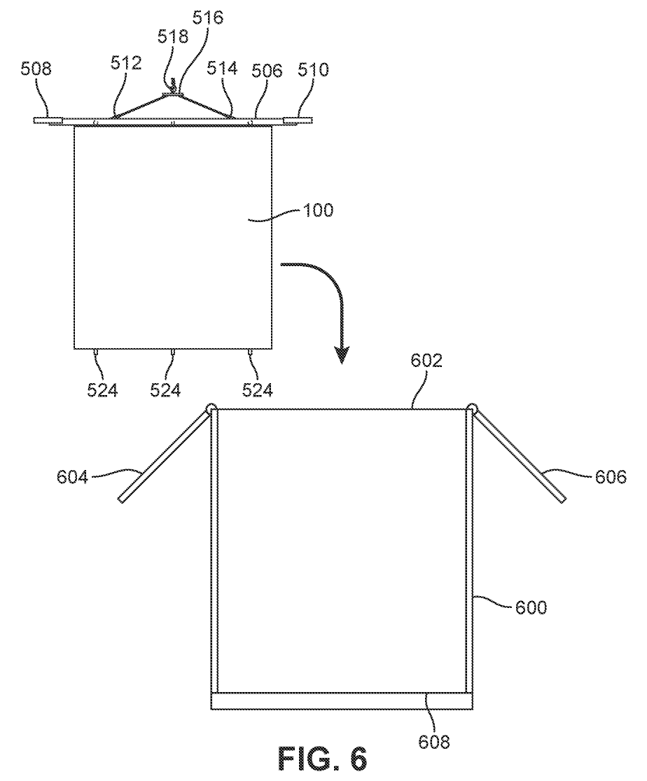

Top conveyor 504 can have the same features as those described as top conveyor 204. For example, top conveyor 504 can have a track with a u-shaped channel and a slot extending along a bottom wall of the track. One difference between top conveyor 504 and top conveyor 204 is that top conveyor 504 has a removable track section 506. This removable track section can enable a wall mounted in the track by pins to be lifted along with the removable track section. For example, as shown in FIGS. 5 and 6, a lifting attachment 516 can be attached to removable track section 506 at first connection 512 and second connection 514. In this way, a ring of lifting attachment 516 can be attached to a hoist 518 that can lift removable track section 506 and wall 100. Removable track section 506 may be placed back on the track of top conveyor 504 at a first terminal end 522 and a second terminal end 520 of the track.

Only a hook of a hoist is shown in FIGS. 5 and 6, however, it is understood that a hoist may have a rope or cable connected to the hook at one end and a pulley system, pneumatic system, and/or motor connected to the other end that can aid in lifting removable track section 506 and wall 100. Removable track section 506 may include a first stopper 508 and a second stopper 510. The stoppers may be placed on a first end and a second end of the removable track section to prevent the wall from sliding off the removable track section when the removable track section is lifted and/or moved. In some embodiments, the stoppers may be magnetically attached to the removable track section, such that the stoppers can be easily connected and/or disconnected from the removable track section. In this way, no mating connection mechanism is needed on the removable track section. Thus, the channel of the track can be unobstructed when the stoppers are removed and the removable track section is placed back on the track.

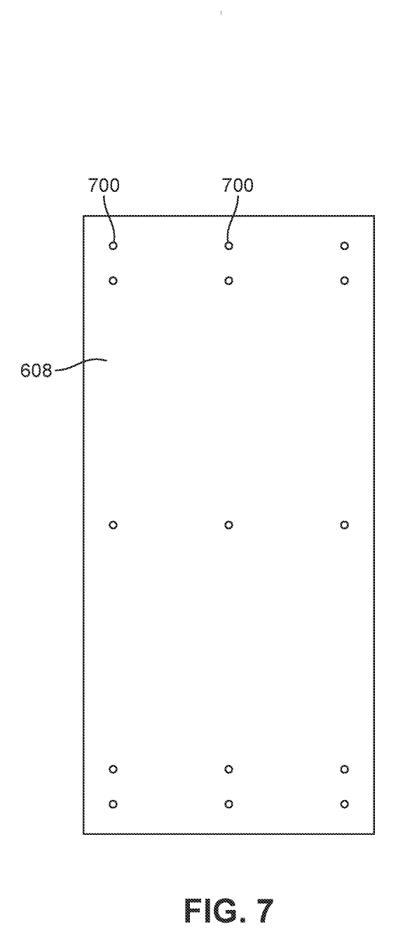

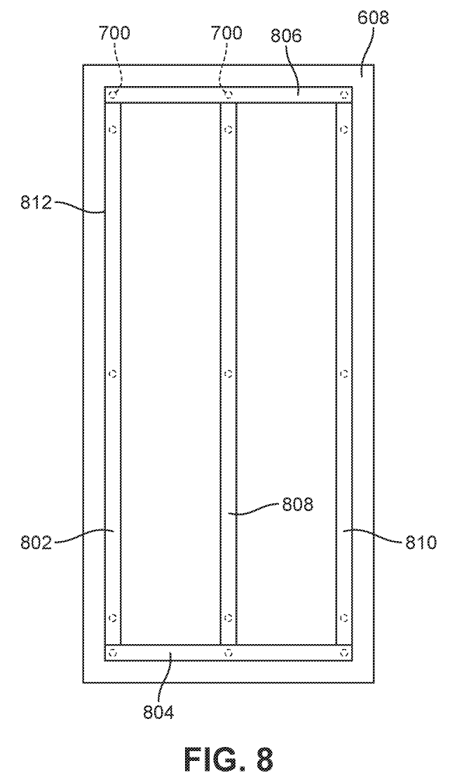

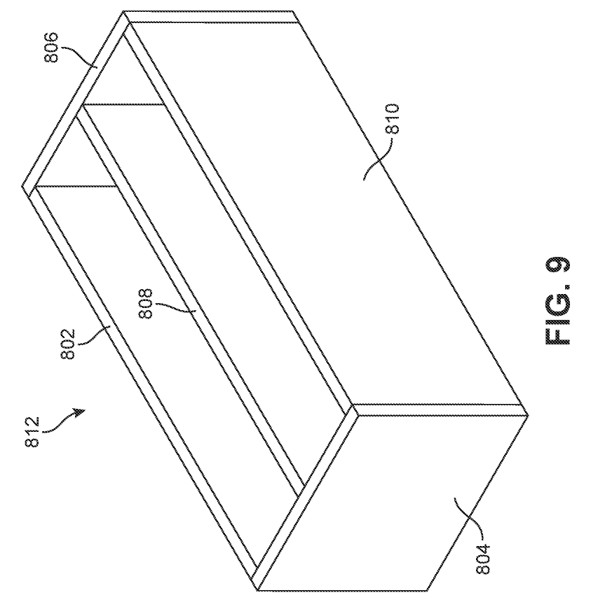

FIG. 6 shows a rear view of a swap body 600 having a first door 604 and a second door 606 that can close to enclose a roof opening 602 of swap body 600. In FIG. 6, the doors are shown open to expose roof opening 602 to receive wall 100. The hoist can load multiple walls inside swap body 600. FIGS. 7 and 8 show how a floor 608 of swap body 600, which can either be a built-in floor or a removable board, can include a pattern of holes 700. The holes can receive pegs 524 or other types of protrusions, or connection mechanisms, provided on the bottom of wall 100. By providing pegs on the bottom of the walls, the walls can be placed in corresponding holes to align the walls in a wall module pattern and the wall module can be efficiently built on floor 608. FIG. 8 shows multiple walls positioned in a wall module pattern on floor 608. First wall 802, second wall 804, third wall 806, fourth wall 808, and fifth wall 810 can be connected to one another (e.g., by screws) to construct a wall module 812. FIG. 9 shows a perspective view of completed wall module 812. Once the wall module is constructed, the pegs can be removed. In other embodiments, the walls can have holes instead of pegs and the swap body floor can have corresponding pegs instead of holes.

While various embodiments of the disclosure have been described, the description is intended to be exemplary, rather than limiting and it will be apparent to those of ordinary skill in the art that many more embodiments and implementations are possible that are within the scope of the disclosure. Various modifications and changes may be made within the scope of this disclosure.

We claim:

1. A wall moving system comprising:
a bottom conveyor including a base and a plurality of rollers rotatably connected to the base;
a top conveyor including a track with a channel and a slot, the top conveyor disposed above the bottom conveyor such that the top conveyor is parallel to the top conveyor;
a first spherical pin having a first substantially spherically shaped head, a first neck, and a first threaded rod; and
a second spherical pin having a second substantially spherically shaped head, a second neck, and a second threaded rod.

2, The wall moving system claim 1, further including a cylindrically shaped pin having a threaded rod.

3. The wall moving system of claim 1, wherein the channel is u-shaped and the slot extends along a longitudinal axis of the channel.

4. The wall moving system of claim 3, wherein the first neck and the second neck are cylindrical in shape.

5. The wall moving system of claim 4, wherein the first neck and the second neck both have a diameter that fits within the slot.

6. The wall moving system of claim 1, wherein the bottom conveyor is a gravity roller conveyor.

7. The wall moving system claim 1, wherein the bottom conveyor is a line-shaft conveyor.

8. A wall moving system comprising:
a bottom conveyor including a base and a plurality of rollers rotatably connected to the base;
a top conveyor including a track with a channel and a slot, the top conveyor disposed above the bottom conveyor such that the top conveyor is parallel to the top conveyor;
a first support suspending the top conveyor above the bottom conveyor;
a first pin having a first head, a first neck that is smaller than the first head, and a first threaded rod; and
a second pin having a second head, a second neck that is smaller than the second head, and a second threaded rod.

9. The wall moving system claim 8, further including a cylindrically shaped pin having a threaded rod.

10. The wall moving system of claim 8, wherein the channel is u-shaped and the slot extends along a longitudinal axis of the channel.

11. The wall moving system of claim 10, wherein the first neck and the second neck are cylindrical in shape.

12. The wall moving system of claim 11, wherein the first neck and the second neck both have a diameter that fits within the slot.

13. The wall moving system of claim 8, wherein the bottom conveyor is a gravity roller conveyor.

14. The wall moving system claim 1, wherein the bottom conveyor is a line-shaft conveyor.

15. A wall moving system comprising:
a bottom conveyor including a base and a plurality of rollers rotatably connected to the base;
a top conveyor including a first track with a first channel and a first slot, the top conveyor disposed above the bottom conveyor such that the top conveyor is parallel to the top conveyor;
a first pin having a first head, a first neck that is smaller than the first head, and a first threaded rod;
a second pin having a second head, a second neck that is smaller than the second head, and a second threaded rod; and
a second track with a second channel and second slot, the second track mountable in a swap body.

16. The wall moving system claim 15, wherein the base includes legs adjustable to change a height of the base.

17. The wall moving system claim 15, wherein the base includes wheels.

18. The wall moving system claim 17, further comprising legs, wherein the wheels are attached to the legs.

19. The wall moving system of claim 15, wherein the bottom conveyor is a gravity roller conveyor.

20. The wall moving system claim 15, wherein the bottom conveyor is a line-shaft conveyor.
